(19) United States
(12) Patent Application Publication
(10) Pub. No.: US 2025/0120530 A1
(43) Pub. Date: Apr. 17, 2025

(54) CURTAIN DRIVE DEVICE

(71) Applicant: NINGBO SUNFREE MOTOR TECHNOLOGY COMPANY LIMITED, Ningbo City, Zhejiang Province (CN)

(72) Inventors: Chun JIANG, Ningbo City, Zhejiang Province (CN); Jianhong WEI, Ningbo City, Zhejiang Province (CN)

(21) Appl. No.: 18/723,110

(22) PCT Filed: Mar. 21, 2022
(86) PCT No.: PCT/CN2022/081914

§ 371 Date: Jun. 21, 2024

(30) Foreign Application Priority Data
Dec. 21, 2021 (CN) 202123234374.4

(51) Int. Cl. A47H 5/02; H02K 5/24

(52) U.S. Cl. CPC A47H 5/02; H02K 5/24

(57) ABSTRACT

A curtain drive device is provided which comprises a housing, a control part, a power supply part and a drive part; the housing comprises a first housing part for accommodating the control part, a second housing part for accommodating the power supply part, and a third housing part for accommodating the drive part; the power supply part and the drive part are both electrically connected to the control part, and a vibration damping module is disposed between the drive part and the third housing part. A vibration damping module is disposed between the drive part and the third housing part in the present disclosure to change the existing hard connection between the drive part and the third housing part to soft connection, so as to filter the vibration generated by the drive part and reduce the vibration transfer, achieving the vibration reduction and noise reduction.

The present application is a U.S. National Stage application of PCT Application No. PCT/CN2022/081914 filed on Mar. 21, 2022, which claims the benefit of priority from the China Patent Application No. 202123234374.4, filed on Dec. 21, 2021, the disclosures of which are hereby incorporated by reference in their entireties.

### TECHNICAL FIELD

The present disclosure relates to the technical field of electric curtains and in particular to a curtain drive device.

### BACKGROUND

Along with the advance of technologies and sciences, the living level of people continuously improves and household products also become smarter and smarter. For example, the traditional curtains all shift toward smart curtains and therefore, the smart use of the curtains can be achieved. The smart use of the curtains lies in that a drive device is mounted in the curtains. The people can control the curtains to automatically open or close by using a terminal such as a smart phone or remote controller or the like. Generally, the drive device comprises a motor and a speed reducer, where the motor and the speed reducer are fixedly connected to a housing of the drive device by screws. The motor and the speed reducer may generate vibration during operation, and these vibrations can be transferred to those elements connected with the motor, especially to the housing of the drive device and the curtain mounting tube and the like, generating noises. Therefore, it is necessary to develop a method of filtering these vibrations and noises.

### SUMMARY

In order to solve the technical problems in the prior arts, the present disclosure provides a noise-reducing and vibration-damping curtain drive device.

In order to solve the above technical problems, the present disclosure adopts the following technical solution: there is provided a curtain drive device which comprises a housing, a control part, a power supply part and a drive part. The housing comprises a first housing part for accommodating the control part, a second housing part for accommodating the power supply part, and a third housing part for accommodating the drive part. The power supply part and the drive part are both electrically connected to the control part. A vibration damping module is disposed between the drive part and the third housing part.

Furthermore, the second housing part and the third housing part are both detachably connected with the first housing part, and the second housing part and the third housing part are both in communication with the first housing part.

Furthermore, the second housing part and the third housing part are both perpendicularly connected with the first housing part. The second housing part and the third housing part are disposed up and down in parallel. A first connection position connected with the second housing part and a second connection position connected with the third housing part are disposed on the first housing part.

Furthermore, the vibration damping module comprises at least one flexible vibration damping sleeve which is fully or partly wrapped on the drive part, with its inner circumferential wall attached to an outer circumferential wall of the drive part and its outer circumferential wall attached to an inner circumferential wall of the third housing part.

Furthermore, two flexible vibration damping sleeves are disposed, which comprise a first flexible vibration damping sleeve and a second flexible vibration damping sleeve. The first flexible vibration damping sleeve is wrapped on an output end of the drive part away from the second connection position, and the second flexible vibration damping sleeve is wrapped on an end of the drive part close to the second connection position. An end of the second flexible vibration damping sleeve goes beyond the end of the drive part and an end surface of the excess part of the second flexible vibration damping sleeve is in contact with an end surface of the second connection position. An end of the first flexible vibration damping sleeve goes beyond an end of the output end of the drive part, and an end surface of the excess part of the first flexible vibration damping sleeve is in contact with an inner end surface of the third housing part.

Furthermore, one circle of inwardly-protruding blocking part is disposed in the flexible vibration damping sleeve to achieve axial limitation for the drive part.

Furthermore, catching grooves are disposed symmetrically on the outer circumference of the second connection position, and catches cooperating with the catching grooves are disposed on the third housing part.

Furthermore, a signal magnet extending into the second connection position is disposed at an end of the drive part close to the second connection position. A protective hood for protecting the signal magnet is integrally formed inside the second connection position.

Furthermore, the second housing part comprises an upper housing part and a lower housing part. The upper housing part is connected to the first connection position by screws, and the lower housing part is fitted to the upper housing part. A power supply part mounting position and a smart module mounting position are disposed inside the second housing part. The smart module mounting position is close to the first connection position, and the power supply part mounting position is away from the first connection position.

Furthermore, a detachable cover plate is disposed on the first housing part.

Compared with the prior arts, the present disclosure has the following advantages: in the present disclosure, a vibration damping module is disposed between the drive part and the third housing part to change the existing hard connection between the drive part and the third housing part to soft connection, so as to filter the vibration generated by the drive part and reduce the vibration transfer, achieving the vibration reduction and noise reduction.

### BRIEF DESCRIPTION OF THE DRAWINGS

In order to describe the embodiments of the present invention or the technical solution of the prior art more clearly, brief descriptions will be made below to the accompanying drawings involved in descriptions of the embodiments or the prior art. Obviously, the accompanying drawings are merely illustrative, and other drawings may also be obtained by those skilled in the art based on these drawings without paying creative work.

The structures, scales, sizes and the like depicted in the specification are only used by those skilled in the art to know and read the contents disclosed by the specification rather than to limit the embodiments of the present disclosure. Therefore, the structures, scales, sizes and the like do not have technically substantive meanings. Any modification, changes or adjustment to the structures, the scales and sizes shall all fall within the scope of protection covered by the technical contents disclosed by the present invention without affecting the effects and the purposes achieved by the present invention.

FIG. 1 is a structural schematic diagram of the present disclosure.

FIG. 2 is a structural schematic diagram of another angle of the present disclosure.

FIG. 3 is an exploded view of the present disclosure.

FIG. 4 is a front view of the present disclosure.

FIG. 5 is a front view of the present disclosure with a third housing part removed.

FIG. 6 is a sectional view of the present disclosure.

FIG. 7 is a structural schematic diagram illustrating a flexible vibration damping sleeve according to the present disclosure.

Numerals of the drawings are described below: 1. first housing part, 1.1 first connection position, 1.2 second connection position, 1.3 catching groove, 1.4 cover plate, 1.5 protective hood, 2. second housing part, 2.1 upper housing part, 2.2 lower housing part, 2.3 power supply part mounting position, 2.4 smart module mounting position, 3. third housing part, 3.1 catch, 4. control part, 5. power supply part, 6. drive part, 6.1 signal magnet, 7. flexible vibration damping sleeve, 7.1 first flexible vibration damping sleeve, 7.2 second flexible vibration damping sleeve, and 7.3 blocking part.

### DETAILED DESCRIPTIONS OF EMBODIMENTS

The present invention will be further detailed below in combination with specific embodiments.

In the descriptions of the present invention, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present invention.

Further, the terms “first” and “second” are used for descriptions only and shall not be understood as indicating or implying relative importance or implicitly indicating the number of the indicated features. As a result, the features defined by “first” and “second” may explicitly or implicitly include at least one feature. In the descriptions of the present invention, the meaning of “several” refers to at least two, for example, two or three or the like, unless otherwise clearly stated.

In the present invention, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present invention according to actual situations.

In the present invention, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

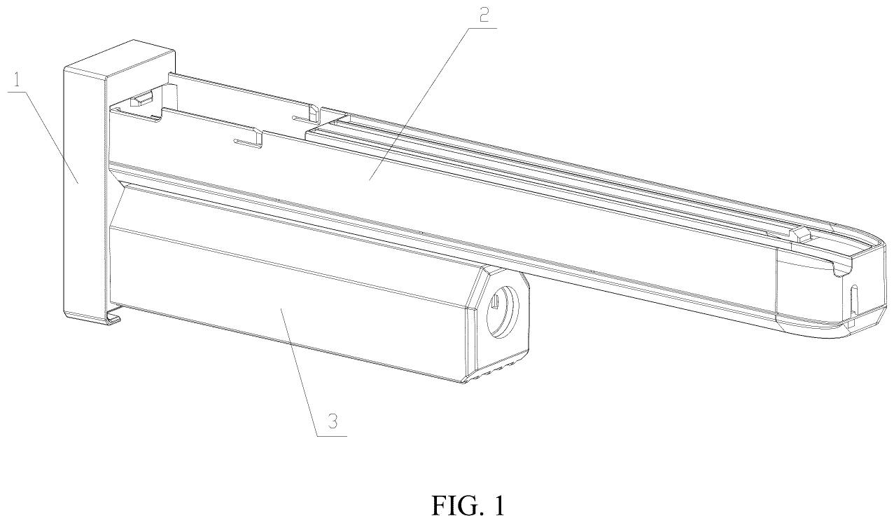

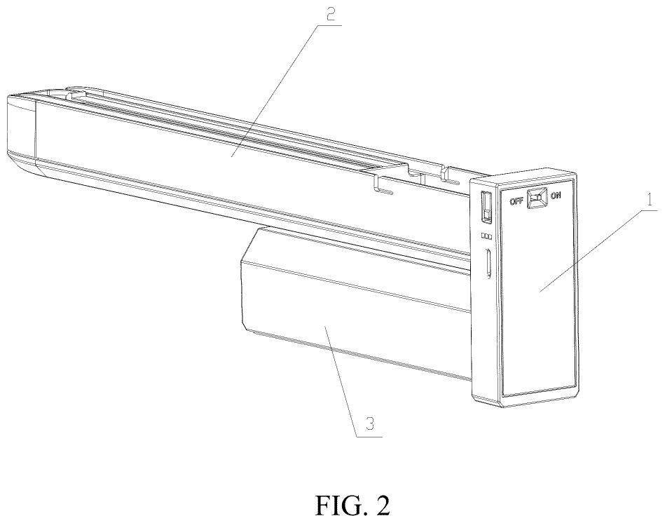

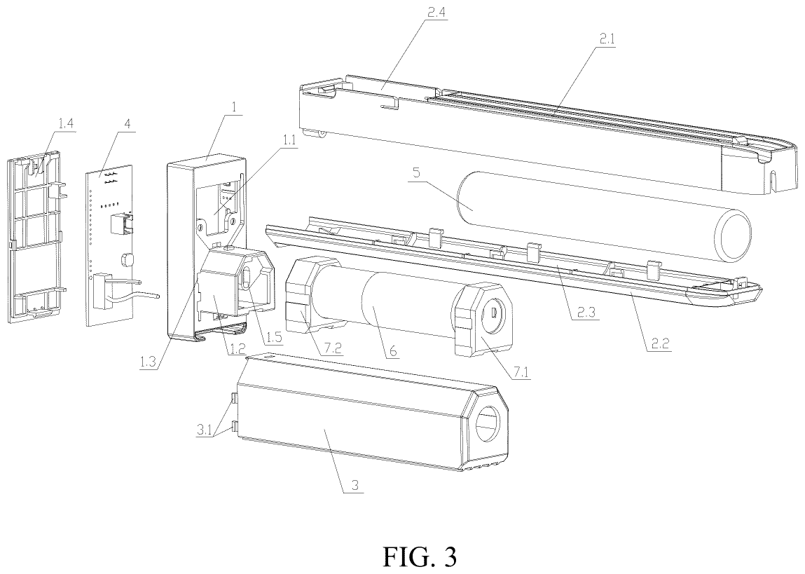

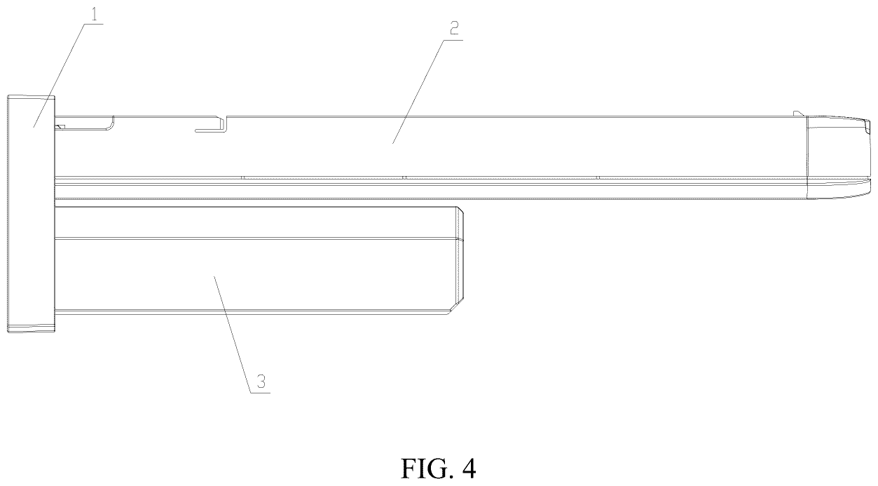

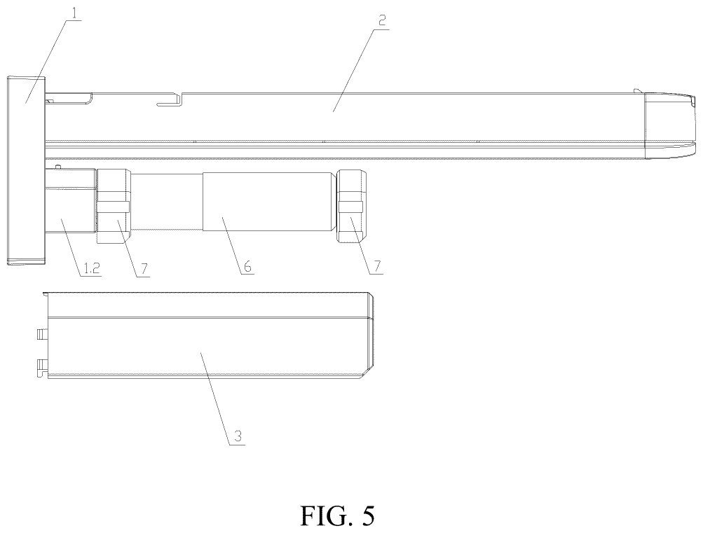

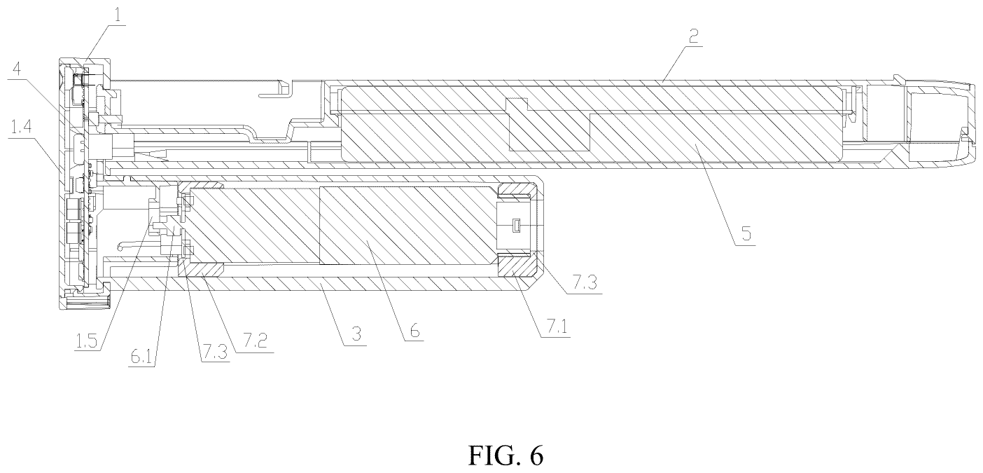

As shown in FIGS. 1 to 7, the present disclosure provides a curtain drive device, which comprises a housing, a control part 4, a power supply part 5 and a drive part 6. The housing comprises a first housing part 1 for accommodating the control part 4, a second housing part 2 for accommodating the power supply part 5, and a third housing part 3 for accommodating the drive part 6. The power supply part 5 and the drive part 6 are both electrically connected to the control part 4. A vibration damping module is disposed between the drive part 6 and the third housing part 3.

The second housing part 2 and the third housing part 3 may be integrally formed with the first housing part 1 or detachably connected with the first housing part 1. Preferably, the second housing part 2 and the third housing part 3 are both detachably connected with the first housing part 1. This structure facilitates assembling, change and maintenance of the control part 4, the power supply part 5 and the drive part 6. Further, the second housing part 2 and the third housing part 3 are both in communication with the first housing part 1 so as to help the power supply part 5 and the drive part 6 to electrically connect with the control part 4, bringing convenience to line connection.

Further preferably, the second housing part 2 and the third housing part 3 are both perpendicularly connected with the first housing part 1, and the second housing part 2 and the third housing part 3 are disposed up and down in parallel. This structure is similar to a horizontal U-shape. Compared with the traditional straight tube-shaped drive device, the drive device of the present disclosure is entirely shorter, and thus can be applied not only to those skylights but also to those short small-size curtains installed on narrow toilet rooms and storage rooms. Furthermore, the first housing part 1 is shaped like a vertical flat plate and hence has a small thickness, which further reduces the entire length of the device. Moreover, the first housing part 1 is a plastic housing which will not shield the signals of the control part 4. The second housing part 2 and the third housing part 3 are also plastic housings, making them lighter and more inexpensive. A first connection position 1.1 connected with the second housing part 2 and a second connection position 1.2 connected with the third housing part 3 are disposed on the first housing part 1. The first connection position 1.1 is located above the second connection position 1.2 and the second connection position 1.2 protrudes out of the first housing part 1 to help connection between the second connection position 1.2 and the third housing part 3.

The vibration damping module comprises at least one flexible vibration damping sleeve 7 which is fully or partly wrapped on the drive part 6. The full wrapping refers to that the flexible vibration damping sleeve 7 is a closed shape, for example, circle, tetragon and pentagon and the like. The partial wrapping refers to that the flexible vibration damping sleeve 7 is a non-closed shape, for example, semicircle, inverted U-shape and arch shape and the like. The flexible vibration damping sleeve 7 is disposed between the drive part 6 and the third housing part 3, with its inner circumferential wall attached to an outer circumferential wall of the drive part 6 and its outer circumferential wall attached to an inner circumferential wall of the third housing part 3. The flexible vibration damping sleeve 7 can not only achieve the limiting mounting for the drive part 6, but also accomplish the filtering and absorbing effect for the vibration generated by the drive part 6, reducing vibration transfer between the drive part 6 and the third housing part 3 and realizing the vibration reduction and noise reduction.

Further preferably, two flexible vibration damping sleeves 7 are disposed, which comprise a first flexible vibration damping sleeve 7.1 and a second flexible vibration damping sleeve 7.2. The first flexible vibration damping sleeve 7.1 is wrapped on an output end of the drive part 6 away from the second connection position 1.2, and the second flexible vibration damping sleeve 7.2 is wrapped on an end of the drive part 6 close to the second connection position 1.2. Further, an end of the second flexible vibration damping sleeve 7.2 goes beyond the end of the drive part 6 and an end surface of the excess part of the second flexible vibration damping sleeve 7.2 is in contact with an end surface of the second connection position 1.2. An end of the first flexible vibration damping sleeve 7.1 goes beyond an end of the output end of the drive part 6, and an end surface of the excess part of the first flexible vibration damping sleeve 7.1 is in contact with an inner end surface of the third housing part 3. In this case, the front end (the output end) and the rear end (the end close to the second connection position) and the circumferential wall of the drive part 6 are not in direct contact with the third housing part 3 and the first housing part 1, further reducing the vibration transfer. Compared with the existing hard connections realized by fasteners such as screws and the like, the soft connection structure of the present disclosure can better achieve the vibration filtering effect. In the present disclosure, the control part 4, the power supply part 5 and the drive part 6 are separately disposed by the first housing part 1, the second housing part 2 and the third housing part 3 to reduce their mutual interference and diminish the potential safety hazards. In this way, more mounting space is provided to the control part 4, the power supply part 5 and the drive part 6 while the entire length of the drive device is shortened. Thus, more smart parts can be mounted as required, making the electric curtain smarter. Furthermore, the flexible vibration damping sleeve 7 is disposed between the drive part 6 and the third housing part 3 to block the vibration transfer between the third housing part 3 and the first housing part 1 and filter the vibration generated by the drive part 6. Therefore, the vibration transferred to the third housing part 3, the first housing part 1 and the curtain mounting tube can be reduced, making the electric curtain more noiseless, quieter and safer in use.

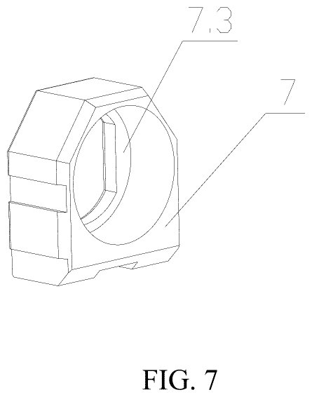

Further preferably, as shown in FIG. 7, one circle of inwardly-protruding blocking part 7.3 is disposed in the flexible vibration damping sleeve 7 to achieve axial limitation for the drive part 6 and prevent the drive part 6 at work from moving axially and hence coming in direct contact with the end of the second connection position 1.2 of the first housing part 1 or the inner end surface of the third housing part 3, reducing vibration transfer.

Catching grooves 1.3 are disposed symmetrically on the outer circumference of the second connection position 1.2, and catches 3.1 cooperating with the catching grooves 1.3 are disposed on the third housing part 3. With the disposal of this structure, assembling and disassembling can be achieved without using any auxiliary tools, saving time and labor. Further, the second connection position 1.2 protrudes out of the first housing part 1 and therefore there is an overlapping part after the third housing part 3 is connected in an insertion way with the second connection position 1.2, such that the third housing part 3 and the first housing part 1 can be more stably connected. The groove mouths of the catching grooves 1.3 are flush with the end surface of the first housing part 1 such that the connection structure of the catches 3.1 and the catching grooves 1.3 can be hidden after the third housing part 3 is fitted to the first housing part 1, making the entire structure tidier and more beautiful. The number of the catching grooves 1.3 may be determined based on actual requirements, for example, one or two groups of catching grooves 1.3 which are symmetrical left and right may be disposed, and the number of the catches 3.1 corresponds to that of the catching grooves 1.3, which ensures the third housing part 3 can be stably connected with the first housing part 1.

A signal magnet 6.1 extending into the second connection position 1.2 is disposed at an end of the drive part 6 close to the second connection position 1.2. A protective hood 1.5 for protecting the signal magnet 6.1 is integrally formed inside the second connection position 1.2. Since electrical lines for electrically connecting the drive part 6 with the control part 4 all run through the second connection position 1.2, the protective hood 1.5 can separate the signal magnet 6.1 from the electrical lines to prevent any interference generated by the scratch of the electrical lines to the signal magnet 6.1. The signal magnet 6.1 and the output end of the drive part 6 rotate coaxially. By sensing the rotation of the signal magnet 6.1 by a Hall sensor, the number of rotation turns of the motor can be calculated. Generally, the Hall sensor is mounted on the control part 4.

The second housing part 2 comprises an upper housing part 2.1 and a lower housing part 2.2. The upper housing part 2.1 is connected to the first connection position 1.1 by screws, and the lower housing part 2.2 is fitted to the upper housing part 2.1. The upper housing part 2.1 can be more firmly fixed and connected by screws and the lower housing part 2.2 can be fitted to the upper housing part 2.1 which facilitates assembling and disassembling. During assembling and disassembling, it is no need to dismount the upper housing part 2.1 but only dismount the lower housing part 2.2, bringing much convenience. A power supply part mounting position 2.3 and a smart module mounting position 2.4 are disposed inside the second housing part 2. The smart module mounting position 2.4 is close to the first connection position 1.1, and the power supply part mounting position 2.3 is away from the first connection position 1.1. The disposal of the smart module mounting position 2.4 helps people to mount a smart module with a different function based on actual requirements, making the drive device smarter, carrying out more smart operations, and simplifying the assembling and disassembling. An external control device, for example, a smart phone or a remote controller or the like, may connect with the smart module in a wired or wireless way, and thus a user may input a control instruction by the external control device and send it to the smart module for processing, and then to the control part, and hence the control part controls the drive part to operate.

A detachable cover plate 1.4 is disposed on the first housing part 1. The disposal of this structure helps people to mount or dismount the control part 4 inside. Further, when the cover plate 1.4 is covered on the first housing part 1, further limiting and protection effect can be achieved for the control part 4.

The control part 4 comprises a master control board on which a switch, an indicator lamp, a setting key and a data interface are disposed. Windows in one-to-one correspondence with the switch, the indicator lamp, the setting key and the data interface are disposed correspondingly on the first housing part 1. The data interface may be a USB interface used for charge or plug-in or data communication. The setting key is used for code matching, reversing or restoration to factory settings. The switch is used to turn on or off the power supply. The indicator lamp is used to display a working state. An on-board antenna may be further disposed on the master control board to receive external signals. The master control board of the present disclosure may be a microcontroller unit (MCU) board, and the power supply part 5 may be a lithium battery or a switching power supply. The drive part 6 comprises a motor and a speed reducer, which are fixedly connected with each other. The flexible vibration damping sleeve 7 is preferably a silica gel vibration damping sleeve.

The materials, reagents and experimental instruments involved in the embodiments of the present disclosure are all commercially-available products in the electric curtain field, unless otherwise stated.

Finally, it is to be pointed out that the above embodiments are merely used to describe the technical solution of the present disclosure rather than limit the present disclosure. Although detailed descriptions are made to the present disclosure by referring to the preceding embodiments, those skilled in the art should understand that the technical solutions recorded in the above embodiments may be modified or part of technical features thereof may be equivalently substituted. Such modifications or substitutions will not cause the essences of the corresponding technical solutions to depart from the spirits and scopes of the technical solutions of various embodiments of the present disclosure.

1. A curtain drive device, wherein the device comprises a housing, a control part, a power supply part and a drive part; the housing comprises a first housing part for accommodating the control part, a second housing part for accommodating the power supply part, and a third housing part for accommodating the drive part; the power supply part and the drive part are both electrically connected to the control part, and a vibration damping module is disposed between the drive part and the third housing part.

2. The curtain drive device of claim 1, wherein the second housing part and the third housing part are both detachably connected with the first housing part, and the second housing part and the third housing part are both in communication with the first housing part.

3. The curtain drive device of claim 2, wherein the second housing part and the third housing part are both perpendicularly connected with the first housing part; the second housing part and the third housing part are disposed up and down in parallel; a first connection position connected with the second housing part and a second connection position connected with the third housing part are disposed on the first housing part.

4. The curtain drive device of claim 3, wherein the vibration damping module comprises at least one flexible vibration damping sleeve which is fully or partly wrapped on the drive part, with its inner circumferential wall attached to an outer circumferential wall of the drive part and its outer circumferential wall attached to an inner circumferential wall of the third housing part.

5. The curtain drive device of claim 4, wherein two flexible vibration damping sleeves are disposed, which comprise a first flexible vibration damping sleeve and a second flexible vibration damping sleeve; the first flexible vibration damping sleeve is wrapped on an output end of the drive part away from the second connection position, and the second flexible vibration damping sleeve is wrapped on an end of the drive part close to the second connection position; an end of the second flexible vibration damping sleeve goes beyond the end of the drive part and an end surface of the excess part of the second flexible vibration damping sleeve is in contact with an end surface of the second connection position; an end of the first flexible vibration damping sleeve goes beyond an end of the output end of the drive part, and an end surface of the excess part of the first flexible vibration damping sleeve is in contact with an inner end surface of the third housing part.

6. The curtain drive device of claim 5, wherein one circle of inwardly-protruding blocking part is disposed in the flexible vibration damping sleeve to achieve axial limitation for the drive part.

7. The curtain drive device of claim 3, wherein catching grooves are disposed symmetrically on the outer circumference of the second connection position, and catches cooperating with the catching grooves are disposed on the third housing part.

8. The curtain drive device of claim 3, wherein a signal magnet extending into the second connection position is disposed at an end of the drive part close to the second connection position; a protective hood for protecting the signal magnet is integrally formed inside the second connection position.

9. The curtain drive device of claim 3, wherein the second housing part comprises an upper housing part and a lower housing part; the upper housing part is connected to the first connection position by screws, and the lower housing part is fitted to the upper housing part; a power supply part mounting position and a smart module mounting position are disposed inside the second housing part; the smart module mounting position is close to the first connection position, and the power supply part mounting position is away from the first connection position.

10. The curtain drive device of claim 3, wherein a detachable cover plate is disposed on the first housing part.

11. The curtain drive device of claim 6, wherein catching grooves are disposed symmetrically on the outer circumference of the second connection position, and catches cooperating with the catching grooves are disposed on the third housing part.

12. The curtain drive device of claim 6, wherein a signal magnet extending into the second connection position is disposed at an end of the drive part close to the second connection position; a protective hood for protecting the signal magnet is integrally formed inside the second connection position.

13. The curtain drive device of claim 6, wherein the second housing part comprises an upper housing part and a lower housing part; the upper housing part is connected to the first connection position by screws, and the lower housing part is fitted to the upper housing part; a power supply part mounting position and a smart module mounting position are disposed inside the second housing part; the smart module mounting position is close to the first connection position, and the power supply part mounting position is away from the first connection position.

14. The curtain drive device of claim 6, wherein a detachable cover plate is disposed on the first housing part.
